(19) United States
(12) Patent Application Publication
(10) Pub. No.: US 2014/0193654 A1
(43) Pub. Date: Jul. 10, 2014

(54) MULTIFUNCTION ACCESSORY

(71) Applicant: Moana Park, Honolulu, HI (US)

(72) Inventor: Moana Park, Honolulu, HI (US)

(21) Appl. No.: 13/736,961

(22) Filed: Jan. 9, 2013

(51) Int. Cl. H04M 1/02

(52) U.S. Cl. CPC H04M 1/02
USPC 428/542.2

(57) ABSTRACT

A multifunction accessory is adapted to attach to at least two charms. Means of attachment to more than one charm is by, for example, including an opening in the accessory, screw threads, magnet and spring. Decorative combinations including the multifunction accessory has one or two charms and can be worn as a neck chain or attached to other items such as a key holder or chain.

### FIELD OF THE INVENTION

The present disclosure generally relates to a multifunction accessory and embodiments thereof; and also relates to combinations including the multifunction accessory useful for serving as decoration and embodiments thereof.

### BACKGROUND OF THE INVENTION

Existing decorative plugs that fit into headphone jacks of mobile phones have a decoration or charm at one end and the other end plugs into the headphone jacks of mobile phones. Thus, only one function is served by the currently existing decorative plugs: serving as decoration when plugged into a headphone jack of a mobile phone. When unplugged, existing decorative headphone jack plugs serve no decorative function.

Therefore, there exists a need in the art for a multifunction accessory which can serve a decorative function beyond just when it is plugged into a headphone jack of an electronic device such as a mobile phone.

### SUMMARY OF THE INVENTION

In an embodiment, a multifunction accessory in accordance with the present disclosure includes a body with two ends. One end of the multifunction accessory is shaped to be plugged into a headphone jack of an electronic device such as a smartphone. The other end is shaped in the form of a connector that can attach to a charm. When unplugged from the headphone jack of an electronic device, the multifunction accessory can attach to a second charm. Thus, when unplugged from the headphone jack, the multifunction accessory can be attached to one or two charms.

The present multifunction accessory can attach to a second charm by various attachment means that include having at least one opening on the shaft, having a screw thread on the shaft, a magnet or metal on the shaft and a spring on the shaft. While the shaft is adapted for attachment to a second charm, the second charm itself can be adapted for easy attachment to the shaft of the multifunction accessory. Examples of such adaptation for easy attachment located on the second charm include having openings, screw threads, magnets or metals, lockers and/or springs.

Many additional structural and operational variations that may be implemented in various examples of the inventive subject matter are provided in the description that follows.

### BRIEF DESCRIPTION OF THE DRAWINGS

FIG. 1a depicts a side view of a multifunction accessory having a shaft opening and a first charm shown separate from the multifunction accessory.

FIG. 1b depicts a top perspective view of a multifunction accessory having a shaft opening and a first charm shown separate from the multifunction accessory.

FIG. 1c depicts a bottom perspective view of a multifunction accessory having a shaft opening and a first charm shown separate from the multifunction accessory.

FIG. 2a depicts a side view of a multifunction accessory having a shaft opening and a first charm shown joined to the multifunction accessory.

FIG. 2b depicts a top perspective view of a multifunction accessory having a shaft opening and a first charm shown joined to the multifunction accessory.

FIG. 3 depicts a smartphone with a multifunction accessory first charm plugged into the smartphone.

FIG. 4a depicts a side view of a multifunction accessory having a screw thread and no shaft opening.

FIG. 4b depicts a side view of a multifunction accessory having a screw thread and a shaft opening.

FIG. 5a depicts a combination of a multifunction accessory with no shaft screw thread, a first charm and a second charm in the shape of a ladybug in a separated state.

FIG. 5b depicts a combination of a multifunction accessory with a shaft screw thread, a first charm and a second charm in a separated state.

FIG. 6a depicts a combination of a multifunction accessory, a first charm and a second charm in a joined state.

FIG. 6b depicts a combination of a multifunction accessory, a first charm and a second charm in a joined state, with the second charm featuring a chain holder.

FIG. 7 depicts a side view of a second charm which includes a side opening.

FIG. 8a depicts a side view of an attachment mechanism between a multifunction accessory and a second charm by lockers in an unlock state.

FIG. 8b depicts a side view of an attachment mechanism between a multifunction accessory and a second charm by lockers in a lock state.

FIG. 9a depicts a top view of an attachment mechanism in an unlock state between a multifunction accessory and a second charm by the use of a spring and by twisting of the multifunction accessory.

FIG. 9b depicts a side view of an attachment mechanism in a lock state between a multifunction accessory and a second charm by the use of a spring and by twisting of the multifunction accessory.

FIG. 9c depicts a top view of an attachment mechanism in a lock state between a multifunction accessory and a second charm by the use of a spring and by twisting of the multifunction accessory.

FIG. 10a depicts a top view of an attachment mechanism in an unlock state between a multifunction accessory and a second charm by the use of a spring and by pressing of the multifunction accessory.

FIG. 10b depicts a side view of an attachment mechanism in a lock state between a multifunction accessory and a second charm by the use of a spring and by pressing of the multifunction accessory.

FIG. 10c depicts a top view of an attachment mechanism in a lock state between a multifunction accessory and a second charm by the use of a spring and by pressing of the multifunction accessory.

### DETAILED DESCRIPTION OF THE INVENTION

The present disclosure generally relates to a multifunction accessory 100 which can fit within a headphone jack of an electronic device and connect to a first charm 102 and additionally serve the function of connecting to a second charm 500 when unplugged from the electronic device. The multifunction accessory comprises a body with two ends wherein the body comprises a shaft 106 adapted to fit within a headphone jack of an electronic device located at one end, and a connector 104 adapted to attach to a first charm located at the other end, and further wherein the shaft is also adapted to attach to a second charm.

The shaft of the body of the present multifunction accessory is shaped so that it can be plugged into a headphone jack or audio jack of an electronic device. The headphone jack size may vary. For example, the jack size may be 3.5 mm or 2.5 mm or 6.35 mm. In another embodiment, the multifunction accessory of the present disclosure may fit into an electronic socket of an electronic device more generally such as a telephone jack. In one form, the shaft of the present multifunction accessory may have a recessed area 110 on the shaft which encircles the shaft widthwise so that it may securely plug into a headphone or audio jack. To unplug, outward force away from the electronic device is applied which overcomes the secure plug. This mechanism is widely used by users to unplug conventional headphones from headphone jacks of electronic devices such as music players and mobile phones and computer.

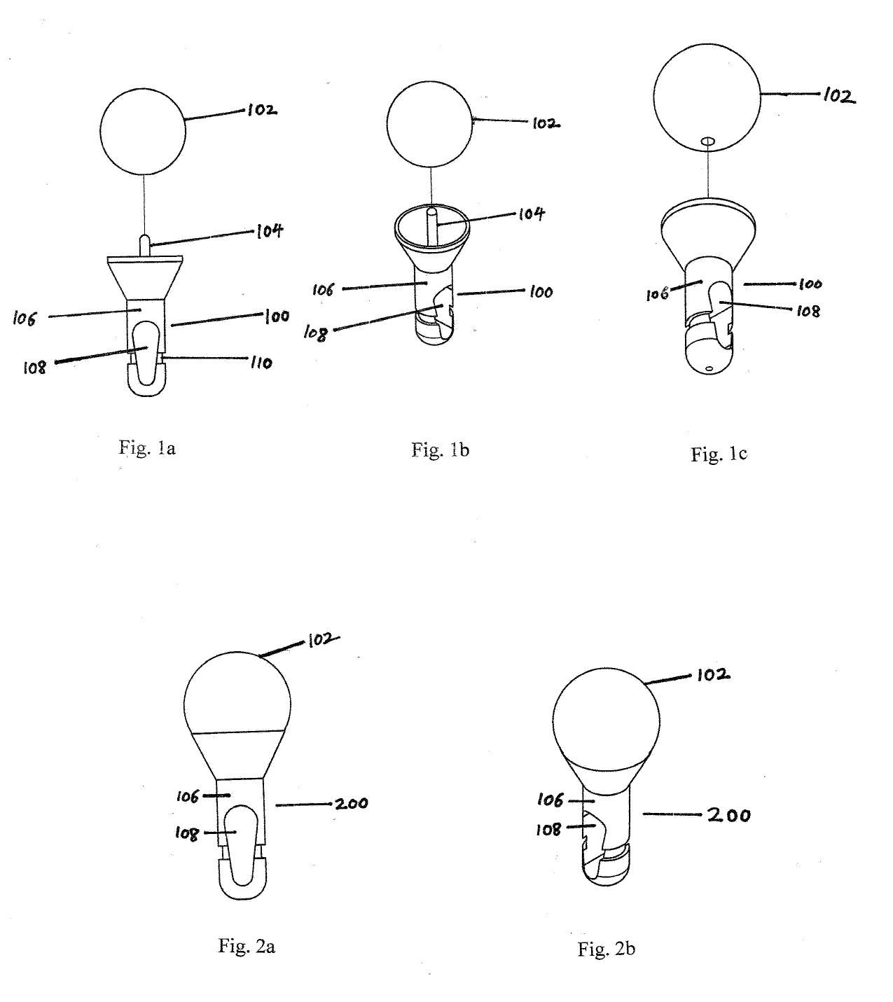

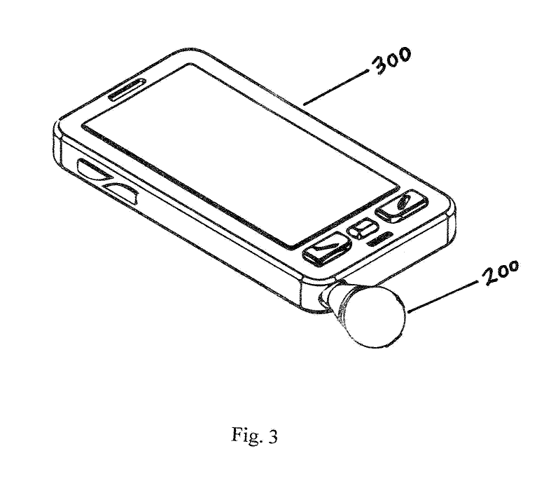

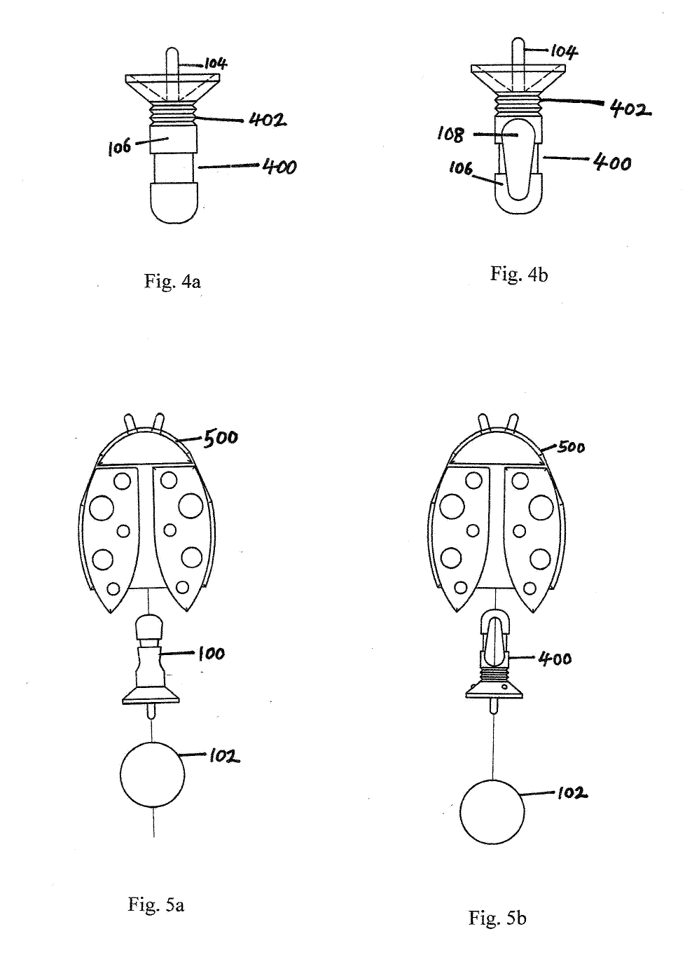

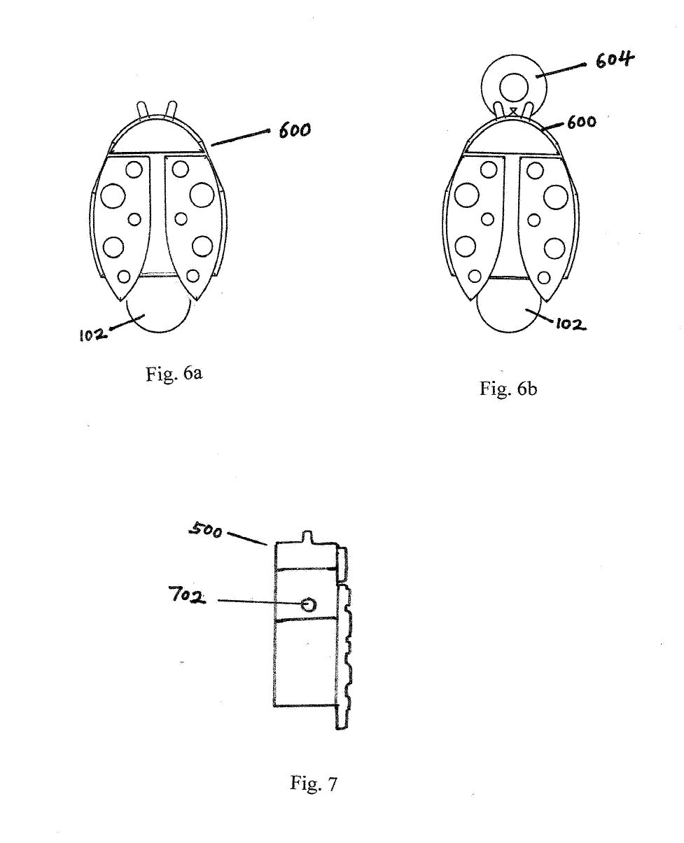

One part of the body of the present multifunction accessory is the shaft. Another part of the body is a connector 104 that can attach to a charm. As illustrated in FIG. 1b from a perspective view, the connector can be elongated in shape so that it can insert and attach to a charm. As an example, such a charm may be a round charm as illustrated in FIGS. 1a-1c. As used herein, the charm which attaches to a connector of the multifunction accessory located at the opposite end of the presently described shaft shall be referred to as the first charm. A multifunction accessory attached to a first charm 200 is illustrated in FIGS. 2a, 2b, and 3. The connection to a first charm may be permanent in one embodiment, i.e., detachment of the first charm may not be easily achieved.

The present multifunction accessory is able to serve a further function in addition to serving as decoration when plugged into a headphone jack of an electronic device such as a smartphone. The further function is made possible by the shaft of the body of the multifunction accessory being adapted to attach to a second charm. As used herein, a charm that is attached to the shaft of the present multifunction accessory shall be referred to as a second charm.

One way or means of adaptation in one embodiment is by the shaft having an opening 108 located on the shaft. The opening as used herein defines a hole in the shaft itself. A multifunction accessory that has such an opening can be attached to a second charm. A second charm can also have an opening on either side of the charm so that an item such as a chain can be threaded through the openings 702 on the charm and also through the opening on the shaft of a multifunction accessory. The multifunction accessory can thus be attached securely to a second charm by utilizing the openings on the second charm and also the opening on the shaft of the multifunction accessory.

In another embodiment, the multifunction accessory 400 of the present disclosure has a shaft that includes a screw thread 402. The screw thread on the shaft serves the function of attachment means to a second charm. The screw thread may be a male thread or a female thread. In the case the screw thread on the multifunction accessory is a male thread, the second charm will contain a screw thread that is a female thread. In the case the screw thread on the multifunction accessory is a female thread, the second charm will contain a screw thread that is a male thread.

In an embodiment, a multifunction accessory in accordance with the present disclosure may have both an opening included on a shaft and a screw thread. In an embodiment, the threading may be located on the portion of the shaft of the multifunction accessory that is located towards the end that has the presently described connector for connecting to a first charm. This location of the screw threading on the shaft facilitates the existence of an opening on the shaft and alongside the existence of the screw threading.

In another embodiment, a multifunction accessory of the present disclosure has a shaft which includes a magnet or metal for attachment to a second charm. When the shaft includes a magnet, then a second charm into which a multifunction accessory will be attached to may contain a metal material so that magnetic force will allow attachment. Alternatively, the second charm may also contain a magnet but has to be in opposite polarity so that there will be an attractive magnetic force. It is also within the scope and content of the present disclosure that the shaft of the multifunction accessory will comprise a metal material that is not magnetic. In this embodiment, the second charm will have a magnetic material on a contact surface for the multifunction accessory so that there will be attractive magnetic force. Adaptation of the shaft of the presently described multifunction accessory permits easy attachment and detachment of the multifunction accessory from a second charm.

In another embodiment, the shaft of the presently described multifunction accessory includes a spring 902 for attachment to a second charm. A spring is placed in conjunction with an extender 904 that extends out when the spring is in a loose position and the withdrawn inward when the spring is in a compressed position. Indentations can be located on the attachment area of a second charm such that when rotated the extenders can line up with the indendations so that the spring goes from an compressed state to a loose state to fill in the indentations. The extenders can be rounded at the ends so that when the multifunction accessory is twisted the spring may be compressed, extenders drawn in, and the multifunction accessory may be taken out from the second charm.

Alternatively, for the embodiment of a multifunction accessory that has a spring, the mechanism for attaching and detaching the multifunction accessory from a second charm may be by pushing into an attachment area of a second charm. Indentations or recessed areas may exist in the attachment area for a second charm and pushing the multifunction accessory into a second charm compresses the spring along with extenders existing in conjunction with the spring located on the shaft. When the extenders line up with indentations then the spring goes from a compressed state to a loose state and locks the multifunction accessory into a second charm. This spring attachment method is similar to the above described spring attachment method except that the attachment and detachment motion is by pushing and pulling and not by twisting.

In another embodiment, the electronic device which has a headphone jack into which the present multifunction accessory may attach or insert is a mobile phone. An example of a mobile phone within the scope and content of the present disclosure is a smartphone 300.

In a further embodiment, the electronic device may be a computer. A computer as envisioned herein may include a desktop computer, laptop computer, or a tablet computer. Additionally, the electronic device may be other devices having an output jack such as a headphone jack which may receive a multifunction accessory of the present disclosure.

The present disclosure also relates to a decorative combination 600 comprising a multifunction accessory comprising a body with two ends wherein the body comprises shaft adapted to fit within a headphone jack of an electronic device located at one end, and a connector adapted to attach to a first charm located at the other end, and further wherein the shaft is also adapted to attach to a second charm, a first charm attached to the connector adapted to attach to the first charm and a second charm attached to the shaft adapted to attach to the second charm. In one embodiment, the second charm may include a chain holder 604.

A shaft of a multifunction accessory which is a part of a decorative combination of the present disclosure may, in one embodiment, as described above for the multifunction accessory by itself, include an opening for attachment to a second charm. As described above, the opening on the shaft of the multifunction accessory can be lined up with corresponding openings on at least two sides of a second charm so that a chain or key ring or other hooking agent can be past through so that the multifunction accessory with a first charm is attached to a second charm. When a chain is passed through, the decoration may be worn around the neck of a user or worn as a bracelet for example. Alternatively, when a key ring or key chain is passed through, a user may carry around the presently described decorative combination along with keys on the key ring or key chain.

In another embodiment, a decorative combination in accordance with the present disclosure may exist without a second charm. In this embodiment, a shaft of a multifunction accessory that is included will have an opening on the shaft so that the decorative combination with the multifunction accessory and a first charm may be worn with a chain passed through (as a necklace or a bracelet as described above) or with a keychain or key ring.

In another embodiment, a decorative combination of the present disclosure has a screw threading which may be male or female screw threading on the shaft of the multifunction accessory. As described above, the screw thread on the shaft serves the function of attachment means to a second charm. The screw thread may be a male thread or a female thread. In the case the screw thread on the multifunction accessory is a male thread, the second charm will contain a screw thread that is a female thread. In the case the screw thread on the multifunction accessory is a female thread, the second charm will contain a screw thread that is a male thread.

In another embodiment of a decorative combination of the present disclosure, a multifunction accessory included in the decorative combination may have, as already described above, both an opening included on a shaft and a screw thread. In an embodiment, the threading may be located on the portion of the shaft of the multifunction accessory that is located towards the end that has the presently described connector for connecting to a first charm. This location of the screw threading on the shaft facilitates the existence of an opening on the shaft and along side the existence of the screw threading.

In another embodiment of a decorative combination of the present disclosure, a multifunction accessory included in the decorative combination may have, as already described above, a shaft which includes a magnet or metal for attachment to a second charm. When the shaft includes a magnet, then a second charm into which a multifunction accessory will be attached to may contain a metal material so that magnetic force will allow attachment. Alternatively, the second charm may also contain a magnet but has to be in opposite polarity so that there will be an attractive magnetic force. It is also within the scope and content of the present disclosure the described decorative combination that the shaft of the multifunction accessory will have or comprise a metal material that is not magnetic in one embodiment. In this embodiment, the second charm will have a magnetic material on a contact surface for the multifunction accessory so that there will be attractive magnetic force. Adaptation of the shaft of the presently described multifunction accessory permit easy attachment and detachment of the multifunction accessory from a second charm.

In another embodiment of a decorative combination of the present disclosure, a multifunction accessory included in the decorative combination may have, as already described above, a multifunction accessory which has a shaft that includes a spring for attachment to a second charm. A spring is placed in conjunction with an extender that extends out when the spring is in a loose position and the withdrawn inward when the spring is in a compressed position. Indentations can be located on the attachment area of a second charm such that when rotated the extenders can line up with the indendations so that the spring goes from an compressed state to a loose state to fill in the indentations. The extenders can be rounded at the ends as illustrated so that when the multifunction accessory is twisted the spring may be compressed, extenders drawn in and the multifunction accessory may be taken out from the second charm.

Alternatively, for the embodiment of a multifunction accessory that has a spring (here for the decorative combination), the mechanism for attaching and detaching the multifunction accessory from a second charm may be by pushing into an attachment area of a second charm. Indentations or recessed areas may exist in the attachment area for a second charm and pushing the multifunction accessory into a second charm compresses the spring along with extenders existing in conjunction with the spring located on the shaft. When the extenders line up with indentations then the spring goes from a compressed state to a loose state and locks the multifunction accessory into a second charm. This spring attachment method is similar to the above described spring attachment method except that the attachment and detachment motion is by pushing and pulling and not by twisting.

In another embodiment of a decorative combination of the present disclosure, the second charm is adapted to attach to the shaft of the multifunction accessory. Adaptation for attachment on the second charm may be by including at least one opening on the second charm. As described above, a neck chain or key chain or key ring, among other things, may be passed through the opening defining a hole on the second charm and also through an opening on a shaft of the multifunction accessory. In another embodiment of a decorative combination of the present disclosure, screw thread, male or female, may be included on the second charm. In yet another embodiment of a decorative combination of the present disclosure, the second charm may include a magnet or metal. Attachment of the second charm to the shaft of the present multifunction accessory by magnetic force has already been described above and applies here for the embodiment of the decorative combination in accordance with the present disclosure.

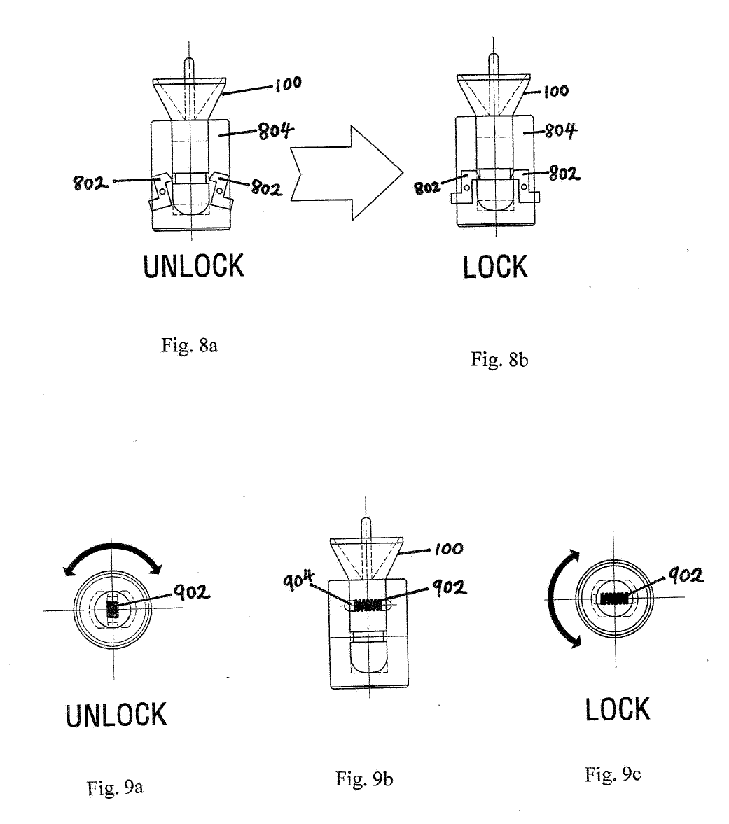

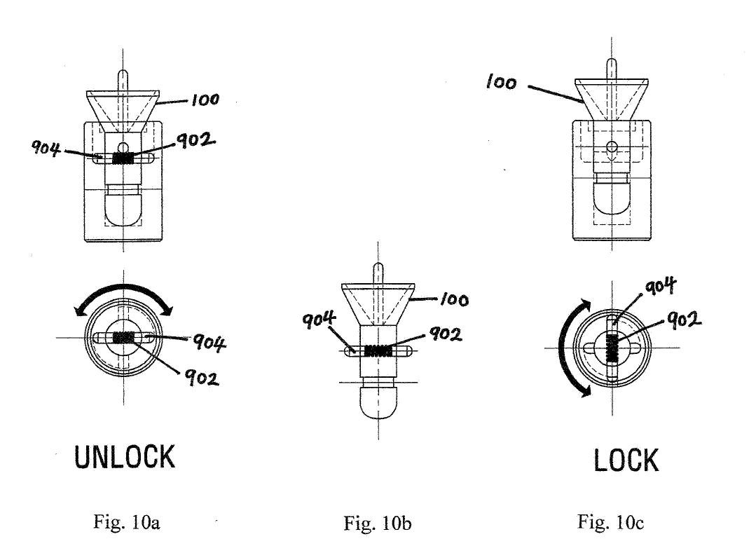

In another embodiment of the present decorative combination the second charm includes at least one locker 802 for attachment by clicking into the shaft of the present multifunction accessory. As illustrated by FIGS. 8a and 8b, the locker serve as a movable protrusion which can lock into a recessed area, or indentation located on the shaft of the multifunction accessory when the accessory is pushed into portion of the second charm 804. To remove, the multifunction accessory may be pulled out by overcoming the force required for removal.

As described above and also applying here for the present decorative combination, the electronic device is a mobile phone or computer or music player. An example of a mobile phone within the scope and content of the present disclosure is a smartphone. In a further embodiment, the electronic device may be a computer. A computer as envisioned herein may include a desktop computer, laptop computer, or a tablet computer. Additionally, the electronic device may be other devices having an output jack such as a headphone jack which may receive a multifunction accessory of the present disclosure.

The present description refers to the accompanying drawings that depict various details of examples selected to show how particular embodiments may be implemented. The discussion herein addresses various examples of the inventive subject matter at least partially in reference to these drawings and describes the depicted embodiments in sufficient detail to enable those skilled in the art to practice the invention. Many other embodiments may be utilized for practicing the inventive subject matter than the illustrative examples discussed herein, and many structural and operational changes in addition to the alternatives specifically discussed herein may be made without departing from the scope of the inventive subject matter.

In this description, references to “one embodiment” or “an embodiment,” or to “one example” or “an example” mean that the feature being referred to is, or may be, included in at least one embodiment or example of the invention. Separate references to “an embodiment” or “one embodiment” or to “one example” or “an example” in this description are not intended to necessarily refer to the same embodiment or example; however, neither are such embodiments mutually exclusive, unless so stated or as will be readily apparent to those of ordinary skill in the art having the benefit of this disclosure. Thus, the present disclosure includes a variety of combinations and/or integrations of the embodiments and examples described herein, as well as further embodiments and examples as defined within the scope of all claims based on this disclosure, as well as all legal equivalents of such claims. The terms “a,” “an,” “the” and similar referents used in the context of describing the invention (especially in the context of the following claims) are to be construed to cover both the singular and the plural, unless otherwise indicated herein or clearly contradicted by context.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. Furthermore, any cited references and printed publications are individually incorporated herein by reference in their entirety.

What is claimed is:

1. A multifunction accessory comprising:
a body with two ends wherein said body comprises a shaft adapted to fit within a headphone jack of an electronic device located at one end, and a connector adapted to attach to a first charm located at the other end; and further wherein said shaft is also adapted to attach to a second charm.

2. The multifunction accessory of claim 1, wherein said shaft includes an opening for attachment to said second charm.

3. The multifunction accessory of claim 1, wherein said shaft includes a screw thread for attachment to said second charm.

4. The multifunction accessory of claim 1, wherein said shaft includes a magnet or metal for attachment to said second charm.

5. The multifunction accessory of claim 1, wherein said shaft includes a spring for attachment to said second charm.

6. The multifunction accessory of claim 1, wherein said electronic device is a mobile phone or computer or music player

7. A decorative combination comprising:
a multifunction accessory comprising a body with two ends wherein said body comprises a shaft adapted to fit within a headphone jack of an electronic device located at one end, and a connector adapted to attach to a first charm located at the other end; and further wherein said shaft is also adapted to attach to a second charm;
a first charm attached to said connector adapted to attach to said first charm;
and a second charm attached to said shaft adapted to attach to said second charm.

8. The decorative combination of claim 7, wherein said shaft includes an opening for attachment to said second charm.

9. The decorative combination of claim 7, wherein said shaft includes a screw thread for attachment to said second charm.

10. The decorative combination of claim 7, wherein said shaft includes a spring for attachment to said second charm.

11. The decorative combination of claim 7, wherein said shaft includes a magnet or a metal for attachment to said second charm.

12. The decorative combination of claim 7, wherein said second charm is adapted to attach to said shaft.

13. The decorative combination of claim 7, wherein said second charm includes at least one opening.

14. The decorative combination of claim 7, wherein said second charm includes a screw thread.

15. The decorative combination of claim 7, wherein said second charm includes a magnet or a metal.

16. The decorative combination of claim 7, wherein said second charm includes at least one locker for attachment by clicking into said shaft.

17. The decorative combination of claim 7, wherein said electronic device is a mobile phone or computer or music player.
